(19) United States
(12) Patent Application Publication
(10) Pub. No.: US 2026/0219217 A1
(43) Pub. Date: Jul. 30, 2026

(54) MEASURING DEVICE AND MEASURING METHOD

(71) Applicant: Yokogawa Electric Corporation, Tokyo (JP)

(72) Inventor: Yasushi ICHIZAWA, Tokyo (JP)

(21) Appl. No.: 19/145,330

(22) PCT Filed: Jan. 22, 2024
(86) PCT No.: PCT/JP2024/001634

§ 371 Date: Jul. 2, 2025

(30) Foreign Application Priority Data
Jan. 27, 2023 (JP) 2023-010897

(51) Int. Cl. G01N 23/16

(52) U.S. Cl. CPC G01N 23/16; G01N 2223/303; G01N 2223/633

(57) ABSTRACT

A measuring device includes a processor configured to acquire first transmission information by scanning an object to be measured with a detector that irradiates a predetermined object of irradiation and detects transmission information of the object of irradiation, acquire second transmission information by scanning a reference sample generated from the object to be measured with the detector, calculate a value relating to a weight or a thickness of the object to be measured from the first transmission information by using a correlation between a reference value relating to a weight or a thickness of the reference sample and the second transmission information, and calibrate the value based on variations of the second transmission information over time.

### TECHNICAL FIELD

The present invention relates to a measuring device and a measuring method.

### BACKGROUND ART

A battery electrode sheet (hereinafter, referred to as “electrode sheet”) is metal foil that is coated with a mixture of active materials and the like and dried. In the electrode sheet manufacturing process, positive electrodes and negative electrodes are respectively manufactured on separate production lines. For example, in the case of the positive electrode, a slurry is thinly and evenly applied to coat a surface of an aluminum foil, and is dried in the next process. After it is dried, a coating process is performed on a rear surface of the aluminum foil in a similar manner, and drying is then performed. As inspections in the coating process to the drying process described above, measurement of basis weight (coating weight per unit area), shape measurement of an end surface of a coated portion (edge), and image diagnosis of a dried surface condition, and the like can be performed.

The basis weight measurement using radiation, such as beta-rays and X-rays, will be explained using FIG. 1. FIG. 1 is a diagram for explaining the basis weight measurement of an electrode sheet. In an apparatus for performing the basis weight measurement illustrated in FIG. 1, an upper measurement head and a lower measurement head are fixed to an upper beam and a lower beam of an O-shaped frame, respectively, and the upper and lower measurement heads scan the inside of the O-shaped frame in synchronization from side to side. The measurement heads of the above apparatus are equipped with a radiation source of beta-rays and X-rays and a detector facing each other, and the transmission attenuation amount of the electrode sheet, which is an object to be measured, is measured. In this case, a calibration curve is obtained by measuring a reference sample with a known basis weight several times, and the basis weight and the thickness of the object to be measured can be calculated from a relationship between the attenuation amount and the calibration curve.

### CITATION LIST

### Patent Literature

[PTL 1]
Japanese Laid-open Patent Publication No. 2003-329430

### SUMMARY OF INVENTION

### Technical Problem

However, it is difficult to obtain accurate measurement values in the basis weight measurement using radiations, such as beta-rays and X-rays. For example, when measuring the basis weight or thickness of an object to be measured using radiations, such as beta-rays and X-rays, it is difficult to accurately measure the basis weight or thickness of the object to be measured due to changes caused by factors such as aging resulting from a beta-ray decay, the output stability of a X-ray source, the temperature drift of the measurement sensitivity of a line sensor, and the like.

The present invention has been achieved in view of the above problems, and it enables to effectively calibrate a measurement value in basis weight measurement using radiations, such as beta-rays and X-rays.

### Solution to Problem

According to an aspect of the embodiments, a measuring device comprising includes an acquiring unit that acquires first transmission information by scanning an object to be measured with a detector that irradiates a predetermined object of irradiation and detects transmission information of the object of irradiation, and that acquires second transmission information by scanning a reference sample generated from the object to be measured with the detector, a calculating unit that calculates a value relating to a weight or a thickness of the object to be measured from the first transmission information by using a correlation between a reference value relating to a weight or a thickness of the reference sample and the second transmission information, and a calibrating unit that calibrates the value based on variations of the second transmission information over time.

According to an aspect of the embodiments, a measuring method that is performed by a computer, the method includes acquiring first transmission information by scanning an object to be measured with a detector that irradiates a predetermined object of irradiation and detects transmission information of the predetermined object of irradiation, and acquiring second transmission information by scanning a reference sample generated from the object to be measured with the detector, calculating a value relating to a weight or a thickness of the object to be measured from the first transmission information by using a correlation between a reference value relating to a weight or a thickness of the reference sample and the second transmission information, and calibrating the value based on variations of the second transmission information over time.

### Advantageous Effects of Invention

According to the present invention, an effect that a measurement value can be effectively calibrated is produced.

### BRIEF DESCRIPTION OF DRAWINGS

FIG. 1 is a diagram for explaining a basis weight measurement of an electrode sheet.

FIG. 2 is a diagram illustrating a configuration example and a processing example of a basis-weight measurement system according to an embodiment.

FIG. 3 is a block diagram illustrating a configuration example of respective devices in the basis-weight measurement system according to the embodiment.

FIG. 4 is a diagram illustrating an example of a measurement-value storage unit of a measuring device according to the embodiment.

FIG. 5 is a diagram illustrating an example of a reference-value storage unit of the measuring device according to the embodiment.

FIG. 6 is a diagram illustrating an example of a calculation-value storage unit of the measurement device according to the embodiment.

FIG. 7 is a diagram illustrating an example of a calibration-value storage unit of the measuring device according to the embodiment.

FIG. 8 is a diagram illustrating an example of a pattern of indication value according to the embodiment.

FIG. 9 is a flowchart illustrating an example of a flow of basis-weight measurement processing according to the embodiment.

FIG. 10 is a diagram explaining a hardware configuration example.

### DESCRIPTION OF EMBODIMENTS

A measuring device and a measuring method according to one embodiment of the present invention will be explained in detail below with reference to the accompanying drawings. The embodiment explained below are not intended to limit the present invention.

### Embodiment

Hereinafter, a configuration and processing of a basis-weight measurement system according to an embodiment, a configuration and processing of a measuring device and the like, and a flow or respective processing will be sequentially explained, and finally, effects of the embodiment will be explained.

### 1. Configuration and Processing of Basis-Weight Measurement System 100

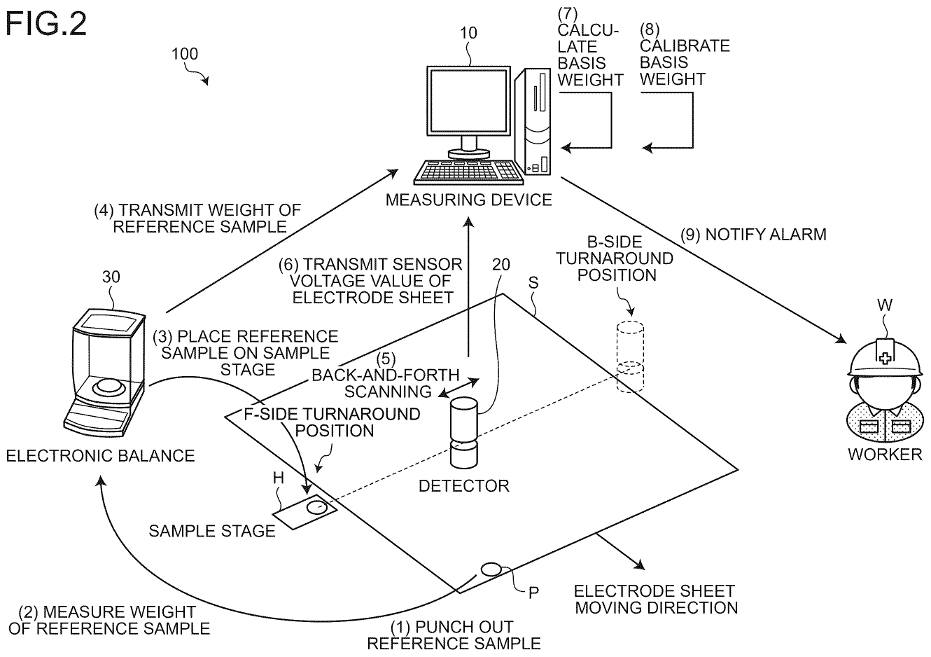

A configuration and processing of a basis-weight measurement system 100 according to the embodiment will be explained in detail using FIG. 2. FIG. 2 is a diagram illustrating a configuration example and a processing example of the basis-weight measurement system 100 according to the embodiment. In the following, a configuration example of the entire basis-weight measurement system 100, a processing example of the basis-weight measurement system 100, and an effect of the basis-weight measurement system 100 will be explained. In the embodiment, it is explained with a measuring device 10 that measures a basis weight and a thickness of an electrode sheet S online as an example, but it is also applicable to a device with a generation source (source) that varies, such as a radiation source, a light source, and a heat source, a device that measures an object to be measured without a gap in measurement, other devices that control the device, and the like, and it is not to limit objects to be measured or a field of application.

### 1-1. Configuration Example of Entire Basis-Weight Measurement System 100

The basis-weight measurement system 100 includes a measuring device 10, a detector 20, and an electronic balance 30 that is used by a worker W. The measuring device 10, the detector 20, and the electronic balance 30 are connected to one another through a predetermined communication network not illustrated in a communication-enabled manner wiredly or wirelessly.

The detector 20 is constituted of an X-ray source and a measurement head, and is arranged perpendicular to a moving direction of the electrode sheet S, and arranged so as to scan the electrode sheet S and the sample stage H back and forth along the electrode sheet S. The electrode S is fed out in a specific direction as a continuous sheet on each production line. Moreover, the sample stage H is a stage on which a reference sample P described later can be placed, and is arranged at an F-side turnaround point that is closer to an arrangement position of the electronic balance 30 out of turnaround positions when the detector 20 performs back-and-forth scanning.

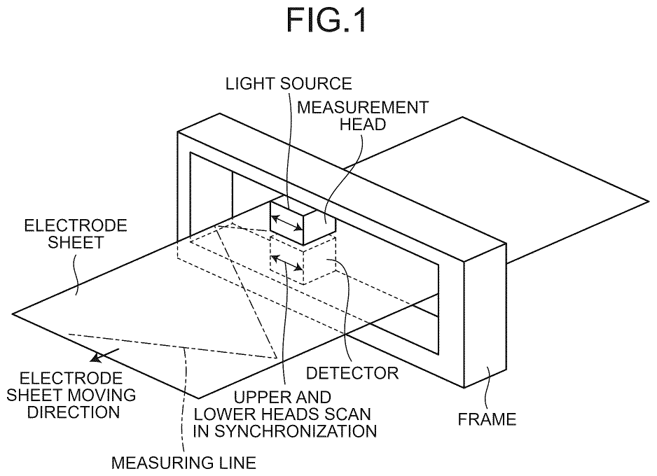

The basis-weight measurement system 100 illustrated in FIG. 2 may include multiple units of the measuring device 10, multiple units of the detector 20, multiple units of the electronic balance 30, or multiple units of the sample stage H. Furthermore, the sample stage H may be arranged at a B-side turnaround position that is far from the arrangement position of the electronic balance 30, or may be arranged at both the F-side turnaround position and the B-side turnaround position. Moreover, FIG. 1 illustrates a case in which the measuring device 10 is implemented by a desktop personal computer (PC), but it may be implemented by a server device, a cloud system, or the like.

### 1-2. Processing Example of Basis-Weight Measurement System 100

A processing example of the basis-weight measurement system 100 as described above will be explained. In the following, reference-value acquisition processing, measurement-value acquisition processing, indication-value calculation processing, indication-value calibration processing, and alarm notification processing will be sequentially explained. The processing described below may also be performed in different order. Moreover, the processing described below may include processing to be omitted.

### 1-2-1. Reference-Value Acquisition Processing

The worker W punches out a portion of the electrode sheet S, which is an object to be measured as the reference sample P with a known area (refer to FIG. 2(1)), measures an accurate weight of the reference sample P by using the electronic balance 30 (refer to FIG. 2(2)), and places the reference sample P on the sample stage H (refer to FIG. 2 (3)). The electronic balance 30 transmits the weight [g] of the measured reference sample P to the measuring device 10 as a reference value (refer to FIG. 2(4)). At this time, the electronic balance 30 may transmit a basis weight [g/m²] obtained by dividing the weight of the reference sample P by its area, or a thickness [micrometer] obtained by multiplying the basis weight by a density [g/m³] of the electrode sheet S to the measuring device 10 as the reference value. Moreover, the worker W may input the weight [g] of the reference sample P measured by using the electronic balance 30, the calculated basis weight [g/m²], and the thickness [micrometer] to the measuring device 10.

The object to be measured is not limited to a metal foil, such as the electrode sheet S, but may be a sheet-shaped object, such as paper and plastic films.

### 1-2-2. Measurement-Value Acquisition Processing

The detector 20 scans the moving electrode sheet S back and forth (refer to FIG. 2(5)). In this case, the detector 20 measures an X-ray transmission intensity of the electrode sheet S, and measures an X-ray transmission intensity of the reference sample P on the sample stage H arranged at the F-side turnaround position. Moreover, the detector 20 may measure an X-ray transmission intensity of air at the B-side turnaround position. The detector 20 transmits sensor voltage values of the measured X-ray transmission intensities of the electrode sheet S, the reference sample P, and air to the measuring device 10 as the measurement values (refer to FIG. 2(6)).

### 1-2-3. Indication-Value Calculation Processing

The measuring device 10 calculates a basis weight by using the reference value and the measurement value as the indication value (refer to FIG. 2(7)). In this case, the measuring device 10 calculates the basis weight [g/m²] of the electrode sheet S at each measurement time by using the basis weight [g/m²] obtained by dividing the weight of the reference sample P by its area as the reference value, and the sensor voltage values of the electrode sheet S, the reference sample P, and air as the measurement values. Moreover, the measuring device 10 may calculate the thickness [micrometer] by multiplying the calculated basis weight [g/m²] of the electrode sheet S by the density [g/m³] of the electrode sheet S as the indication value. The indication value is a value relating to a weight or a thickness of an object to be measured that is calculated by using the reference value and the measurement value, and is not limited to the basis weight and the thickness.

### 1-2-4. Indication-Value Calibration Processing

The measuring device 10 calibrates a basis weight based on variations of the measurement value of the reference sample P over time (refer to FIG. 2(8)). At this time, the measuring device 10 identifies various kinds of abnormalities, such as a dose reduction of the X-ray source, contamination of a measurement window surface originated from adhesion of coating liquid or detachment debris of the coating material, sensitivity degradation of the detector 20, and unexpected malfunctions (for example, synchronization failure between the X-ray source and the detector 20), and calibrates the indication value, such as the basis weight and the thickness, by correcting a basis weight conversion factor according to the identified abnormality.

### 1-2-5. Alarm Notification Processing

The measuring device 10 notifies an alarm to the worker W when a measurement value exceeds a predetermined threshold (refer to FIG. 2(9)). In this case, when a measurement value exceeds a threshold set for each kind of abnormality, such as identified dose reduction of the X-ray source, contamination of the measurement window surface, decrease in sensitivity of the detector 20, and an unexpected malfunction, the measuring device 10 transmits an alarm notification according to the identified abnormality to a terminal device used by the worker W.

### 1-3. Effect of Basis-Weight Measurement System

In the following, after explaining issues with reference technique 1 and reference technique 2, effects of the basis-weight measurement system 100 will be explained.

### 1-3-1. Overview of Reference Technique 1

In reference technique 1 described in Patent Literature 1, a calibration plate made from the same material as an object to be measured but having a different thickness therefrom is placed next to the object to be measured. A measuring device according to reference technique 1 measures an X-ray transmission intensity of the object to be measured. The measuring device measures the X-ray transmission intensity of calibration plates, which are plural samples with various thicknesses, by using a measuring system used to measure the object to be measured, and obtains the thickness of the object to be measured from a relationship between the X-ray transmission intensity and the thickness or basis weight of the calibration plates based on the measurement values of the calibration plates. In reference technique 1, measurement with calibration plates placed next to the object to be measured is proposed. However, in thickness measurements, it is common to use multiple calibration plates with known basis weight to create calibration curves, to obtain a relationship between X-ray transmission intensity and the thickness or basis weight of the calibration plates in advance to be stored, and to calculate the thickness and the basis weight of the object to be measured.

### 1-3-2. Problems with Reference Technique 1

In reference technique 1, it is necessary to use multiple calibration plates, and the calibration plates need to be placed either at once or to be replaced sequentially by a worker for measurement. In the case of placing multiple calibration plates at once, it causes a problem of increased size of the device due to enlargement of the size of a line camera, and arrangement of an X-ray source requiring a distance because the X-ray source needs to emit X-rays in a wide angle. In the case of sequentially replacing the calibration plates by a worker, it is time-consuming for each replacement, and it causes a problem being practically impossible to perform calibration at short intervals.

### 1-3-3. Overview of Reference Technique 2

In reference technique 2 implemented in a manufacturing site, inspection of an object to be measured is not limited to electrode sheets, and in either case of paper, film, and the like, a punch of a known area (generally, diameter 50 mm) is used to cut out a portion, to be then measured a weight by using an electronic balance, and the basis weight [g/m²] is obtained by dividing by the area. Moreover, in reference technique 2, when a thickness is acquired as an indication value, a thickness of a reference sample precisely cut by using an offline thickness measurement device or the like is measured, and conversion from a basis weight [g/m²] to a thickness [micrometer] is performed by multiplying by a density [g/m³]. At a manufacturing site, because basis weights and thicknesses are managed on a reel basis, the worker measures the weight of the reference sample at the beginning (starting end) of a reel, and also measures the weight of the reference sample at the ending end of the reel if necessary. The worker does not collect intermediate reference samples that span several kilometers, but trusts measurement values obtained from an online thickness measurement device, to use the measurement values for product certification.

### 1-3-4. Problems with Reference Technique 2

In reference technique 2, it is necessary to create a reference sample for each reel, to measure the weight using an electronic balance, and to perform correction of a calibration curve based on the inspection results. Therefore, it causes a problem of hindering labor-saving.

### 1-3-5. Overview of Basis-Weight Measurement System 100

In the basis-weight measurement system 100, the worker W collects multiple pieces of the reference sample P by using a punch from a beginning (starting end) of a reel of the electrode sheet S, measures an accurate weight of the reference sample P by using the electronic balance 30, obtains a basis weight by dividing it by a punch area, places the reference sample P subjected to measurement on the sample stage H, and inputs the basis weight of the placed reference sample P into the measuring device 10, to store the basis weight of the reference sample P to be a reference of calculation of a basis weight therein.

That is, the basis-weight measurement system 100 has a configuration that the weight of the reference sample P punched out by the worker W is measured by using the electronic balance 30, and can be input to the measuring device 10 without discarding the reference sample P after inspection. Furthermore, the basis-weight measurement system 100 is configured to be able to perform measurement of the reference sample P in each back-and-forth scanning by extending a distance of the back-and-forth scanning to be reach the arrangement position of the reference sample P to perform consistent measurement.

Moreover, in the basis-weight measurement system 100, the measuring device 10 calculates a basis weight of the electrode sheet S by using the basis weight of the reference sample P, and sensor voltage values of the electrode sheet S and the reference sample P measured by the detector 20, calibrates the basis weight based on variations of the sensor voltage values of the reference sample P over time, and notifies an alarm to the worker W when the sensor voltage value of the electrode sheet S exceeds a predetermined threshold.

### 1-3-6. Effects of Basis-Weight Measurement System 100

In the basis-weight measurement system 100, it is possible to incorporate calibration into the measurement routine each time. That is, in the basis-weight measurement system 100, there is no transitions between a measurement mode and a calibration mode, and continuous measurement without a gap is possible. Moreover, the basis-weight measurement system 100 enables calibration at short intervals without increasing the size of the device. Furthermore, the basis-weight measurement system 100 enables to achieve labor-saving in correction of a calibration curve, and the like.

As described above, the basis-weight measurement system 100 enables to calibrate a measurement value effectively.

### 2. Configuration of Respective Devices in Basis-Weight Measurement System 100

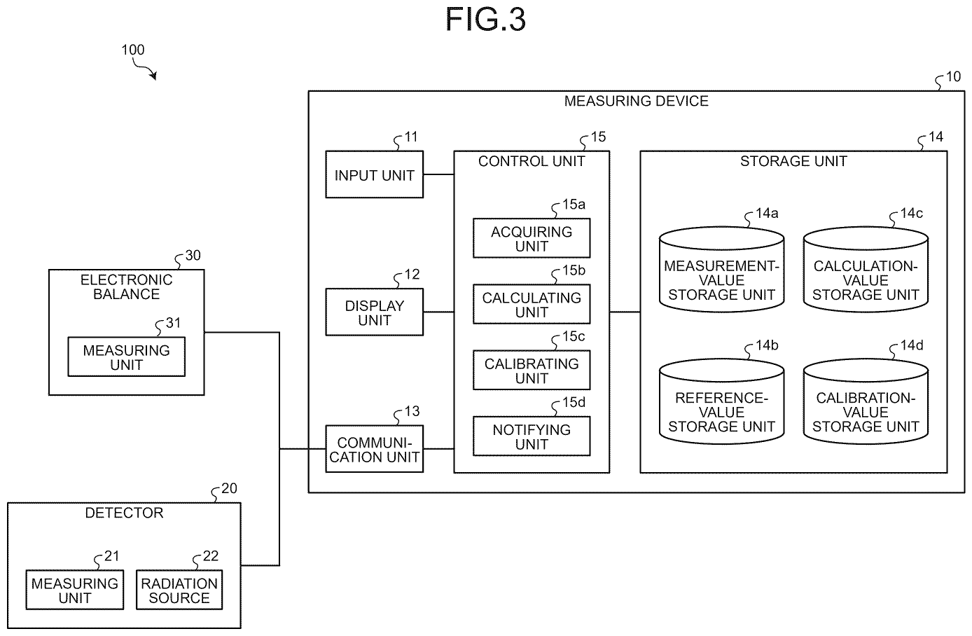

A functional configuration of respective devices included in the basis-weight measurement system 100 illustrated in FIG. 2 will be explained by using FIG. 3. FIG. 3 is a block diagram illustrating a configuration example of respective devices of the basis-weight measurement system 100 according to the embodiment. In the following, after explaining a configuration example of the entire basis-weight measurement system 100 according to the embodiment, configuration examples of the measuring device 10, the detector 20, and the electronic balance 30 according to the embodiment will be explained in detail.

### 2-1. Configuration Example of Entire Basis-Weight Measurement System 100

As illustrated in FIG. 3, the basis-weight measurement system 100 includes the measuring device 10, the detector 20, and the electronic balance 30. The measuring device 10 is connected to the detector 20 and the electronic balance 30 through a predetermined communication network in a communication-enabled manner.

### 2-2. Configuration Example of Measuring Device 10

First, a configuration example of the measuring device 10 will be explained by using FIG. 3. The measuring device 10 includes an input unit 11, an display unit 12, a communication unit 13, a storage unit 14, and a control unit 15.

### 2-2-1. Input Unit 11

The input unit 11 manages input of various kinds of information to the measuring device 10. For example, the input unit 11 is implemented by a mouse, a keyboard, and the like, and accepts an input of setting information and the like to the measuring device 10.

### 2-2-2. Display Unit 12

The display 12 manages output of various kinds of information from the measuring device 10. For example, the display unit 12 is implemented by a display and the like, and displays setting information and the like stored in the measuring device 10.

### 2-2-3. Communication Unit 13

The communication unit 13 manages data communication with other devices. For example, the communication unit 13 performs data communication with respective communication devices through a router and the like. Moreover, the communication unit 13 can perform data communication with a terminal of an operator not illustrated.

### 2-2-4. Storage Unit 14

The storage unit 14 stores various kinds of information referred to when the control unit 15 operates, or various kinds of information acquired when the control unit 15 operates. The storage unit 14 includes a measurement-value storage unit 14a, a reference-value storage unit 14b, a calculation-value storage unit 14c, and calibration-value storage unit 14d. The storage unit 14 can be implemented by a semiconductor memory device, such as a random access memory (RAM) and a flash memory, a storage device, such as a hard disk and an optical disk, or the like. In the example in FIG. 3, the storage unit 14 is arranged inside the measuring device 10, but may be arranged outside of the measuring device 10, or multiple storage units may be arranged.

### 2-2-4-1. Measurement-Value Storage Unit 14a

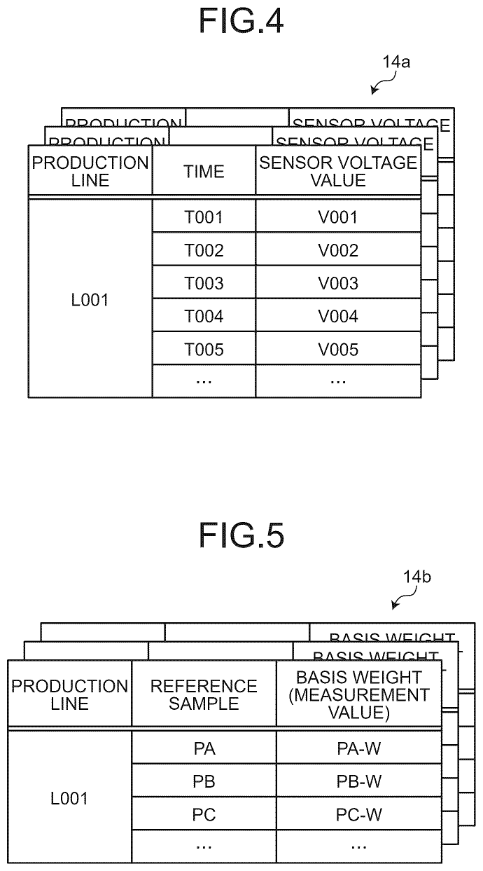

The measurement-value storage unit 14a stores a measurement value measured by the detector 20. An example of data stored by the measurement-value storage unit 14a will be explained by using FIG. 4. FIG. 4 is a diagram illustrating an example of the measurement-value storage unit 14a of the measuring device 10 according to the embodiment. In the example in FIG. 4, the measurement-value storage unit 14a has items, such as “PRODUCTION LINE”, “TIME”, and “SENSOR VOLTAGE VALUE”

“PRODUCTION LINE” indicates identification information to identify a process of manufacturing an object to be measured, which is a subject to measurement, and is, for example, an identification number or an identification symbol of the electrode sheet S. “TIME” indicates a time at which a measurement value is measured, and is expressed by, for example, year, month, day, hour, minute, and second. “SENSOR VOLTAGE VALUE” indicates a conversion value of detection strength, which is a measurement value of an object to be measured, and is expressed by, for example, volt V.

That is, FIG. 4 illustrates an example in which measurement values of a production line identified by “L001” are {TIME: “T001”, SENSOR VOLTAGE VALUE: “V001”}, {TIME: “T002”, SENSOR VOLTAGE VALUE: “V002”}, {TIME: “T003”, SENSOR VOLTAGE VALUE: “V003”}, {TIME: “T004”, SENSOR VOLTAGE VALUE: “V004”}, {TIME: “T005”, SENSOR VOLTAGE VALUE: “V005”},

### 2-2-4-2. Reference-Value Storage Unit 14b

The reference-value storage unit 14b stores a reference value measured by the electronic balance 30. An example of data stored in the reference-value storage unit 14b will be explained by using FIG. 5. FIG. 5 is a diagram illustrating an example of the reference-value storage unit 14b of the measuring device 10 according to the embodiment. In the example in FIG. 5, the reference-value storage unit 14b has items, such as “PRODUCTION LINE”, “REFERENCE SAMPLE”, and “BASIS WEIGHT (MEASUREMENT VALUE)”.

“PRODUCTION LINE” indicates identification information to identify a process of manufacturing an object to be measured, which is a subject to measurement, and is, for example, an identification number or an identification symbol of the electrode sheet S. “REFERENCE SAMPLE” indicates identification information to identify a reference sample collected from an object to be measured, and is, for example, an identification number or an identification symbol of the reference sample P. “BASIS (MEASUREMENT VALUE)” indicates a weight per unit WEIGHT area that is calculated by dividing a weight of each reference sample by an area, and is expressed by, for example, grams per square meter g/m².

That is, FIG. 5 illustrates an example in which reference values of the production line identified by “L001” are {REFERENCE SAMPLE: “PA”, BASIS WEIGHT (MEASUREMENT VALUE): “PA-W”}, {REFERENCE SAMPLE: “PB”, BASIS WEIGHT (MEASUREMENT VALUE): “PB-W”}, {REFERENCE SAMPLE: “PC”, BASIS WEIGHT (MEASUREMENT VALUE): “PC-W”}, . . . .

### 2-2-4-3. Calculation-Value Storage Unit 14c

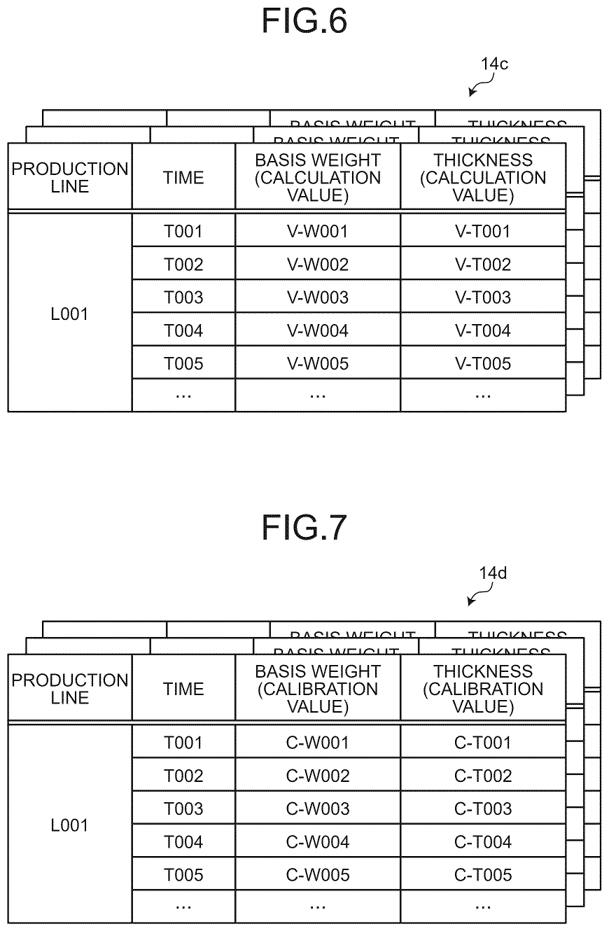

The calculation-value storage unit 14c stores an indication value calculated by a calculating unit 15b of the control unit 15 described later. An example of data stored by the calculation-value storage unit 14c will be explained by using FIG. 6. FIG. 6 is a diagram illustrating an example of the calculation-value storage unit 14c of the measuring device 10 according to the embodiment. In the example in FIG. 6, the calculation-value storage unit 14c has items, such as “PRODUCTION LINE”,“TIME”, “BASIS WEIGHT (CALCULATION VALUE)”, and “THICKNESS (CALCULATION VALUE)”.

“PRODUCTION LINE” indicates identification information to identify a process of manufacturing an object to be measured, which is a subject to measurement, and is, for example, an identification number or an identification symbol of the electrode sheet S. “TIME” indicates a time at which a measurement value is measured, and is expressed by, for example, year, month, day, hour, minute, and second. “BASIS WEIGHT (CALCULATION VALUE)” indicates a weight per unit area calculated from a measurement value of an object to be measured, and is expressed by, for example, grams per square meter g/m². “THICKNESS (CALCULATION VALUE)” indicates a thickness of an object to be measured that is calculated from a measurement value of the object to be measured, and is expressed by, for example, micrometers micrometer.

That is, FIG. 6 illustrates an example in which calculated indication values of the production line identified by “L001” are {TIME: “T001”, BASIS WEIGHT (CALCULATION VALUE): “V-W001”, THICKNESS (CALCULATION VALUE): “V-T001”}, {TIME; “T002”, BASIS WEIGHT (CALCULATION VALUE): “V-W002”, THICKNESS (CALCULATION VALUE): “V-T002”}, {TIME: “T003”, BASIS WEIGHT (CALCULATION VALUE): “V-W003”, THICKNESS (CALCULATION VALUE): “V-T003”}, TIME: “T004”, BASIS WEIGHT (CALCULATION VALUE): “V-W004”, THICKNESS (CALCULATION VALUE): “V-T004”), {TIME: “T005”, BASIS WEIGHT (CALCULATION VALUE): “V-W005”, THICKNESS (CALCULATION VALUE): “V-T005”}, . . . .

### 2-2-4-4. Calibration-Value Storage Unit 14d

The calibration-value storage unit 14d stores an indication value that has been calibrated by a calibrating unit 15c of the control unit 15 described later. An example of data stored by the calibration-value storage unit 14d will be explained by using FIG. 7. FIG. 7 is a diagram illustrating an example of the calibration-value storage unit 14d of the measuring device 10 according to the embodiment. In the example in FIG. 7, the calibration-value storage unit 14d has items, such as “PRODUCTION LINE”, “TIME”, “BASIS WEIGHT (CALIBRATION VALUE)”, and “THICKNESS (CALIBRATION VALUE)”.

“PRODUCTION LINE” indicates identification information to identify a process of manufacturing an object to be measured, which is a subject to measurement, and is, for example, an identification number or an identification symbol of the electrode sheet S. “TIME” indicates a time at which a measurement value is measured, and is expressed by, for example, year, month, day, hour, minute, and second. “BASIS WEIGHT (CALIBRATION VALUE)” indicates a weight per unit area obtained by calibrating the calculated indication value of an object to be measured, and is expressed by, for example, grams per square meter g/m². “THICKNESS (CALIBRATION VALUE)” indicates a thickness of an object to be measured that is obtained by calibrating the calculated indication value of the object to be measured, and is expressed by, for example, micrometers micrometer.

That is, FIG. 7 illustrates an example in which calculated indication values of the production line identified by “1001” are {TIME: “T001”, BASIS WEIGHT (CALIBRATION VALUE): “C-W001”, THICKNESS (CALIBRATION VALUE): “C-T001”}, {TIME: “T002”, BASIS WEIGHT (CALIBRATION VALUE): “C-W002”, THICKNESS (CALIBRATION VALUE): “C-T002”}, {TIME: “T003”, BASIS WEIGHT (CALIBRATION VALUE): “C-W003”, THICKNESS (CALIBRATION VALUE): “C-T003”}, {TIME: “T004”, BASIS WEIGHT (CALIBRATION VALUE): “C-W004”, THICKNESS (CALIBRATION VALUE): “C-T004”}, {TIME: “T005”, BASIS WEIGHT (CALIBRATION VALUE): “C-W005”, THICKNESS (CALIBRATION VALUE): “C-T005”}; . . . .

### 2-2-5. Control Unit 15

The control unit 15 manages overall control of the measuring device 10. The control unit 15 includes an acquiring unit 15a, a calculating unit 15b, a calibrating unit 15c, and a notifying unit 15d. The control unit 15 can be implemented by, for example, an electronic circuit, such as a central processing unit (CPU) and a micro processing unit (MPU), or an integrated circuit, such as an application specific integrated circuit (ASIC) and a field programmable gate array (FPGA).

### 2-2-5-1. Acquiring Unit 15a

The acquiring unit 15a acquires various kinds of data. In the following, measurement-value acquisition processing and reference-value acquisition processing will be explained sequentially.

### Measurement-Value Acquisition Processing

First, the acquiring unit 15a acquires an object measurement value indicating transmission information (first transmission information) of an object of irradiation with respect to an object to be measured, a reference measurement value indicating transmission information (second transmission information) of an object of irradiation with respect to a reference sample, and an air measurement value indicating transmission information (third transmission information) of an object of irradiation with respect to air. For example, the acquiring unit 15a acquires the first transmission information by scanning the electrode sheet S, which is an object to be measured, with the detector 20 that detects transmission information of an object of irradiation by irradiating the predetermined object of irradiation, and acquires the second transmission information by scanning the reference sample P that is a reference sample generated from the electrode sheet S with the detector 20.

The acquiring unit 15a stores measurement values including the acquired object measurement value, the reference measurement value and the air measurement value in the measurement-value storage unit 14a. In this case, the acquiring unit 15a stores the measurement values that are associated with times at which the object measurement value, the reference measurement value, and the air measurement value are acquired in the measurement-value storage unit 14a. Moreover, the transmission information may be a transmission attenuation amount of an object of irradiation or the like, besides the transmission intensity of the object of irradiation.

The acquiring unit 15a acquires a transmission intensity (first transmission intensity) of radiation, such as beta-ray and X-ray, that passes through the electrode sheet S as the object measurement value. Moreover, the acquiring unit 15a acquires a transmission intensity (second transmission intensity) of radiation, such as beta-ray and X-ray, that passes through the reference sample P as the reference measurement value.

The acquiring unit 15a acquires the object measurement value measured by the detector 20 that scans back and forth along the electrode sheet S in a direction perpendicular to a direction in which the sheet-shaped electrode S is fed out. Moreover, the acquiring unit 15a acquires the reference measurement value measured by the detector 20 from at least one of the reference samples placed at the turnaround position during the back-and-forth scanning by the detector 20. Furthermore, the acquiring unit 15a further acquires the air measurement value when the electrode sheet S and the reference sample P are not present, by scanning air with the detector at the turnaround position.

To explain a specific example, the acquiring unit 15a acquires the measurement values that are sensor voltage values of the X-ray transmission intensity measured by the detector 20, {TIME: “T001”, SENSOR VOLTAGE VALUE: “V001”, REFERENCE MEASUREMENT VALUE}, {TIME: “T002”, SENSOR VOLTAGE VALUE: “V002”, OBJECT MEASUREMENT VALUE}, {TIME: “T003”, SENSOR VOLTAGE VALUE: “V003”, OBJECT MEASUREMENT VALUE}, {TIME: “T004”, SENSOR VOLTAGE VALUE: “V004”, OBJECT MEASUREMENT VALUE}, {TIME: “T005”, SENSOR VOLTAGE VALUE; “V005”, AIR MEASUREMENT VALUE}, . . . .

### Reference-Value Acquisition Processing

Second, the acquiring unit 15a acquires a reference value. For example, the acquiring unit 15a acquires a reference value relating to a weight or thickness of the reference sample P, which is a reference sample. In this case, the acquiring unit 15a acquires a weight of the reference sample P collected as a part of the electrode sheet S, which is an object to be measured. The acquiring unit 15a stores the acquired reference value in the reference-value storage unit 14b.

To explain a specific example, the acquiring unit 15a acquires {REFERENCE SAMPLE: “PA”, WEIGHT (MEASUREMENT VALUE): “PA-M”}, {REFERENCE SAMPLE: “PB”, WEIGHT (MEASUREMENT VALUE): “PB-M”}, and {REFERENCE SAMPLE: “PC”, WEIGHT (MEASUREMENT VALUE): “PC-M”} as weights of the multiple reference samples P (PA, PB, PC) measured by the worker W by using the electronic balance 30. Moreover, the acquiring unit 15a acquires {REFERENCE SAMPLE: “PA”, BASIS WEIGHT (MEASUREMENT VALUE): “PA-W”}, {REFERENCE SAMPLE; “PB”, BASIS WEIGHT (MEASUREMENT VALUE): “PB-W”}, and {REFERENCE SAMPLE: “PC”, BASIS WEIGHT (MEASUREMENT VALUE): “PC-W”} as basis weights of the multiple reference samples P (PA, PB, PC). Furthermore, the acquiring unit 15a acquires {REFERENCE SAMPLE: “PA”, THICKNESS (MEASUREMENT VALUE): “PA-T”}, {REFERENCE SAMPLE: “PB”, THICKNESS (MEASUREMENT VALUE): “PB-T”}, and {REFERENCE SAMPLE: “PC”, THICKNESS (MEASUREMENT VALUE): “PC-T”} as thicknesses calculated from the weights of the multiple reference samples P (PA, PB, PC).

### 2-2-5-2. Calculating Unit 15b

The calculating unit 15b calculates an indication value. For example, the calculating unit 15b calculates an indication value that is a value relating to a weight or a thickness of the electrode sheet S, which is an object to be measured from the object measurement value (first transmission information) by using a correlation between a reference value relating to a weight or a thickness of the reference sample P, which is a reference sample, and the reference measurement value (second transmission information). The indication value is a numerical value that indicates a weight or a thickness of the electrode sheet S, which is an object to be measured, and is a numerical value output by processing of the calculating unit 15b. For example, the indication value is a basis weight or a thickness of the electrode sheet S, but is not particularly limited. The calculating unit 15b stores a calculation value that is a calculated indication value in the calculation-value storage unit 14c.

To explain about an indication value to be calculated, the calculating unit 15b calculates a basis weight or a thickness of the electrode sheet S from the transmission intensity (first transmission intensity) of radiation that passes through the electrode sheet S by using a calibration curve indicating a correlation between a basis weight of the reference sample P calculated from the weight of the reference sample P and the transmission intensity (second transmission intensity) of radiation that passes through the reference sample P.

To explain about an example of the calibration curve, the calculating unit 15b generates a calibration curve using two factors of the reference measurement value of the reference sample P and the air measurement value from the basis weight “PA-W” and the reference measurement value “V001” of the reference sample PA arranged at the F-side turnaround position, and the basis weight (0 g/m²) and the air measurement value “V005” of air at the B-side turnaround position. Furthermore, the calculating unit 15b may generate a calibration curve using two factors of the reference measurement value of the reference sample PA and the reference measurement value of the reference sample PB from the basis weight “PA-W” and the reference measurement value “V001” of the reference sample PA arranged at the F-side turnaround position and the basis weight “PB-W” and the reference measurement value “V005” of the reference sample PB arranged at the B-side turnaround position.

### Calculation Value Pattern

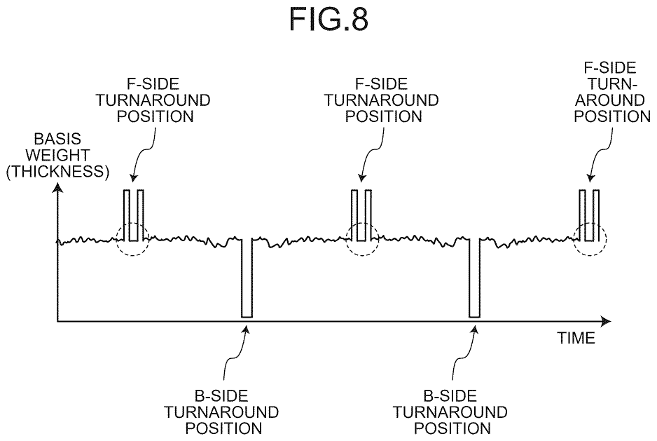

A chronological pattern of indication values calculated by the calculating unit 15b will be explained by using FIG. 8. It is a diagram illustrating an example of a pattern of the indication value according to the embodiment.

In the example in FIG. 8, a schematic diagram of the indication values calculated from a sensor voltage value of each back-and-forth scanning of the detector is illustrated. In a graph in FIG. 8, a horizontal axis represents the passage of time, and the vertical axis represents basis weight or a thickness. As illustrated in FIG. 8, each time the detector 20 makes one back-and-forth scanning, a wave-formed pattern appears. Because air is measured at the B turnaround position, the indication value indicates near zero. On the other hand, because the sample stage H and the reference sample P are measured at the F turnaround position, high indication values (left right of a broken line circle) obtained when the sample stage H is measured and an indication value (center of a broken line circle) obtained when the reference sample P is measured appear.

As explained by the chronological pattern described above, the calculating unit 15b can simultaneously calculate the indication value of the reference sample P and the indication value of the electrode sheet S with each round trip scanning. That is, the processing by the calculating unit 15b described above enables to achieve “continuous measurement” that does not require switching between the measurement mode of the electrode sheet S and the calibration mode, and enables monitoring of integrity of the detector 20, and eliminates necessity of regular calibration.

### 2-2-5-3. Calibrating Unit 15c

The calibrating unit 15c calibrates an indication value. For example, the calibrating unit 15c calibrates an indication value based on variations of the reference measurement value (second transmission information) over time. Moreover, the calibrating unit 15c calibrates an indication value based on variations of the air measurement value (third transmission information) over time. In the following, after explaining about the importance of calibration processing, dose-reduction calibration processing, window-surface-contamination calibration processing, sensitivity-degradation calibration processing, and unexpected-abnormality calibration processing will be explained sequentially. The calibrating unit 15c stores a calibration value, which is a calibrated indication value, in the calibration-value storage unit 14d.

### Importance of Calibration Processing

The online measurement device according to the reference technique described above or the like regularly shifts from the measurement mode to the calibration mode, to perform zero-point calibration (air calibration) by moving to a position at which an object to be measured is absent, and to measure the reference sample P (invariant reference sample having a known value). Moreover, the online measurement device of the reference technique described above or the like sequentially performs two kinds of processing in the measurement mode and the calibration mode, if contamination on the window surface or the like occurs right after calibration in a period between calibrations, assuming it shifts to the calibration mode every one hour, it can result in returning incorrect measurement values for 59 minutes. If the online measurement device described above only monitors measurement values, there are no serious problems, but if it is measurement values used for control, defective products are to be continuously manufactured. Because the measuring device 10 according to the embodiment can perform the calibration processing for autonomously detecting an abnormality immediately, it is significantly valuable as an online measurement device to be used for control.

Moreover, because the online measurement device according to the reference technique described above or the like cannot acquire a measurement value during transition to the calibration mode, measurement gaps occur. On the other hand, the measuring device 10 according to the embodiment can perform measurement of the electrode sheet S continuously all the time without creating gaps.

### Dose-Reduction Calibration Processing

The calibrating unit 15c identifies a dose reduction based on variations of the reference measurement value over time, and calibrates an indication value. For example, the calibrating unit 15c identifies a reduction in a generation amount of a subject of detection based on variations of the reference measurement value over time, and calibrates an indication value by correcting a coefficient used for calculation of the indication value.

Because it is possible to statistically predict a dose reduction of a radiation source 22 originated from source variability (decay of the radiation source 22 or X-ray fluctuations) accurately by using the half-life and the like, the calibrating unit 15c can correct the basis-weight conversion factor in chronological order by inverse operation.

### Window-Surface-Contamination Calibration Processing

The calibrating unit 15c identifies window surface contamination based on variations of the reference measurement value overtime, and calibrates an indication value. For example, the calibrating unit 15c identifies contamination of a measurement window of the detector 20 based on variations of the reference measurement value over time, and calibrates an indication value by correcting a coefficient to be used when the indication value is calculated.

The calibrating unit 15c sets a certain threshold for contamination of the measurement window surface of the detector 20 originated from adhesion of coating liquid or detachment debris of the coating material, and can correct the basis-weight conversion factor temporarily by inverse operation when the measurement value increases due to contamination, thereby continuing the measurement processing.

### Sensitivity-Degradation Calibration Processing

The calibrating unit 15c identifies a sensitivity degradation based on variations of the reference measurement value over time, and calibrates an indication value. For example, the calibrating unit 15c identifies a sensitivity degradation of a detector based on variations of the reference measurement value over time, and corrects a coefficient to be used when the indication value is calculated, to calibrate the indication value.

While the sensitivity degradation of the detector 20 changes over a long term as the radiation dose reduction, the radiation dose can be accurately determined through statistical calculations. Therefore, the calibrating unit 15c can identify deterioration of the detector 20 based on a reduction of an indication value, variations of the indication value, and worsening of the signal-to-noise ratio exceeding that.

### Unexpected-Abnormality Calibration Processing

The calibrating unit 15c identifies an unexpected abnormality based on variations of the reference measurement value over time, and calibrates an indication value. For example, the calibrating unit 15c identifies an abnormality relating to synchronization or a positional relationship between a source of irradiation, such as the radiation source 22, and the detector 20 based on variations of the reference measurement value over time, and corrects a coefficient to be used when an indication value is calculated, to calibrate the indication value.

As for an unexpected malfunction originated from a synchronization error, a positioning error, or the like, an incident radiation dose to the detector 20 decreases when the timing of synchronization processing or a precise positional relationship is disrupted for the source of irradiation, such as a radiation source, and a measurement head. Accordingly, a measurement value appears as if the basis weight has increased, but because it also includes motion and periodic fluctuations, the calibrating unit 15c can identify as a malfunction in a drive system, which is different from that of contamination of a window surface.

### 2-2-5-4. Notifying Unit 15d

The notifying unit 15d notifies an alarm corresponding to an abnormality identified based on variations of the reference measurement value (second transmission information) over time when an object measurement value (second transmission information) exceeds a predetermined value. For example, the notifying unit 15d notifies an alarm corresponding to a reduction in a generation amount of a subject to detection (dose reduction), contamination of a measurement window surface of the detector 20 (window surface contamination), degradation in sensitivity of the detector 20 (sensitivity degradation), an abnormality relating to synchronization or a positional relationship between the generation source and the detector (unexpected abnormality), and the like to the terminal device of the worker W as the abnormality identified by the calibrating unit 15c.

To explain a specific example, the notifying unit 15d notifies an alarm indicating that “A dose of the X-ray source has decreased. Please perform maintenance on the X-ray source” or the like to the worker W when the calibrating unit 15c has identified an abnormality of dose reduction. Moreover, the notifying unit 15d notifies an alarm indicating that “The window surface of the detector is dirty. Please clean if there is adhesion of coating liquid or detachment debris of the coating material” or the like to the worker W when the calibrating unit 15c has identified an abnormality of window surface contamination. Moreover, the notifying unit 15d notifies an alarm indicating that “The detector may be deteriorated. Please repair or replace the detector” or the like to the worker W when the calibrating unit 15c has identified an abnormality of sensitivity degradation. Moreover, the notifying unit 15d notifies an alarm indicating that “A synchronization error or a positional error of the detector may have occurred. Please perform maintenance on the detector or the X-ray source” or the like to the worker W when the calibrating unit 15c has identified an unexpected abnormality.

### 2-3. Configuration Example of Detector 20

A configuration example of the detector 20 will be explained by using FIG. 3. The detector 20 includes a measuring unit 21 and the radiation source 22.

### 2-3-1. Measuring Unit 21

The measuring unit 21 manages measurement of various kinds of information of the detector 20. For example, the measuring unit 21 is implemented by a measurement head having a sensor and the like, and measures a transmission intensity of an object of irradiation.

### 2-3-2. Radiation Source 22

The radiation source 22 is a predetermined generation source (source), and generates an object of irradiation that can be detected by the measuring unit 21. For example, the radiation source 22 is a generation source of radiation, and generates beta-rays or X-rays. Furthermore, the radiation source 22 may be a light source that generates light of a predetermined wavelength, or may be a heat source that generates heat of a predetermined temperature.

### 2-4. Configuration Example of Electronic Balance 30

A configuration example of the electronic balance 30 will be explained by using FIG. 3. The electronic balance 30 includes the measuring unit 21.

### 2-4-1. Measuring Unit 31

The measuring unit 31 manages measurement of various kinds of information of the electronic balance 30. For example, the measuring unit 31 is implemented by a weighing dish and a display monitor, and measures a weight of the reference sample P placed on the weighing dish, and displays the measured weight on the display monitor. In this case, the measuring unit 31 may transmit the measured weight of the reference sample P to the measuring device 10.

### 3. Flow of Processing of Basis-Weight Measurement System 100

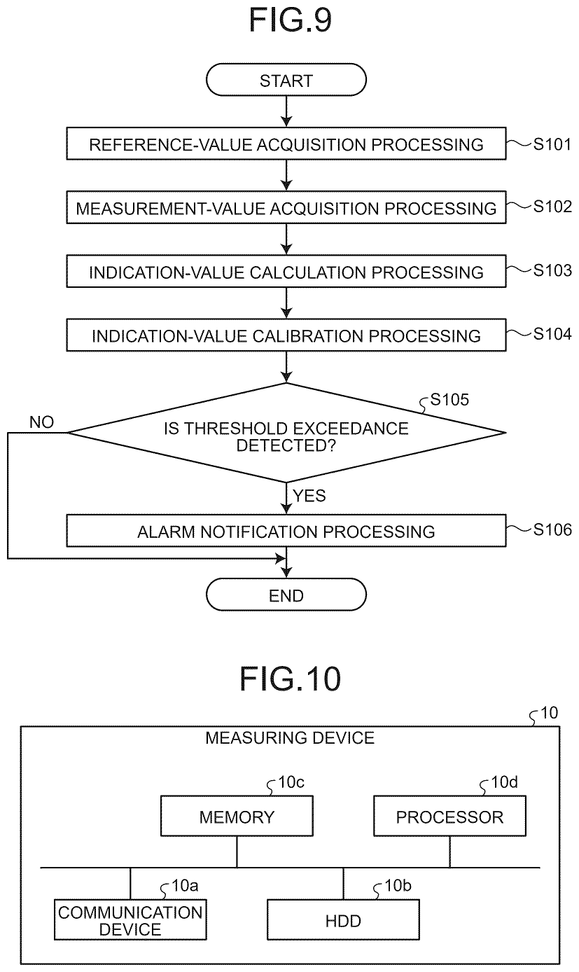

A flow of processing of the basis-weight measurement system 100 according to the embodiment will be explained by using FIG. 9. FIG. 9 is a flowchart illustrating a flow of the basis-weight measurement processing according to the embodiment. In the following, the reference-value acquisition processing, the measurement-value acquisition processing, the indication-value calculation processing, the indication-value calibration processing, and the alarm notification processing will be explained sequentially. Processing at steps S101 to S106 described below can be performed in different order. Moreover, the processing at steps S101 to S106 described below may include processing to be omitted.

### 3-1. Reference-Value Acquisition Processing

First, the measuring device 10 performs the reference-value acquisition processing (step S101). For example, the measuring device 10 acquires a weight of the reference sample P measured by the electronic balance 30 as a reference value.

### 3-2. Measurement-Value Acquisition Processing

Second, the measuring device 10 performs the measurement-value acquisition processing (step S102). For example, the measuring device 10 acquires X-ray transmission intensities and sensor voltage values of the electrode sheet S, the reference sample P, and air measured by the detector 20 as the measurement values.

### 3-3. Indication-Value Calculation Processing

Third, the measuring device 10 performs the indication-value calculation processing (step S103). For example, the measuring device 10 calculates a basis weight [g/m²] or a thickness [micrometer] of the electrode sheet S by using a basis weight [g/m²] obtained by dividing the weight of the reference sample P by its area and the sensor voltage values of the electrode sheet S, the reference sample P, and air, at each measurement time.

### 3-4. Indication-Value Calibration Processing

Fourth, the measuring device 10 performs the indication-value calibration processing (step S104). For example, the measuring device 10 identifies various kinds of abnormalities, such as a dose reduction of the X-ray source, contamination of the measurement window surface, sensitivity degradation of the detector 20, and an unexpected malfunction, based on variations of the measurement value of the reference sample P over time, and corrects the basis-weight conversion factor according to the identified abnormality, to calibrate the indication value of a basis weight, a thickness, or the like.

### 3-5. Indication-Value Calibration Processing

Fifth, the measuring device 10 performs, when a threshold exceedance is detected (step S105: YES), the alarm notification processing (step S106). For example, when a measurement value exceeds a threshold set for each of identified abnormalities, such as a dose reduction of the X-ray source, contamination of a measurement window surface, sensitivity degradation of the detector 20, and an unexpected malfunction, the measuring device 10 transmits an alarm according to the identified abnormality to a terminal used by the worker W.

### 4. Effects of Embodiment

Finally, effects of the embodiment will be explained. In the following, effects 1 to 9 corresponding to the processing according to the embodiment will be explained.

### 4-1. Effect 1

First, in the processing according to the embodiment described above, the measuring device 10 scans the electrode sheet S with the detector 20 that detects a transmission intensity by irradiating a radiation, such as beta-rays or X-rays, to acquire the radiation transmission intensity of the electrode sheet S, scans the reference Sample P generated from the electrode sheet S with the detector 20, to acquire a radiation transmission intensity of the reference sample P, calculates an indication value relating to a weight or a thickness of the electrode sheet S from the radiation transmission intensity of the electrode sheet S by using a correlation between a reference value relating to a weight and a thickness of the reference sample P and the radiation transmission intensity of the reference sample P, and calibrates the calculated indication value based on variations of the radiation transmission intensity of the reference sample P over time. Therefore, in this processing, a measurement value can be effectively calibrated in basis weight measurement using radiations, such as beta-rays or X-rays.

### 4-2. Effect 2

Second, in the processing according to the embodiment described above, the measuring device 10 notifies an alarm corresponding to an abnormality identified based on variations of the radiation transmission intensity of the reference sample P over time when the radiation transmission intensity of the reference sample P exceeds a predetermined value. Therefore, in this processing, a measurement value can be effectively calibrated in the basis weight measurement using radiations, such as beta-rays or X-rays, and an abnormality can be handled appropriately.

### 4-3. Effect 3

Third, in the processing according to the embodiment described above, the measuring device 10 acquires a weight of the reference sample P collected as a portion of the electrode sheet S, acquires the radiation transmission intensity of the electrode sheet S, acquires the radiation transmission intensity of the reference sample P, and calculates a basis weight or a thickness of the electrode sheet S from the radiation transmission intensity of the electrode sheet S by using a calibration curve indicating a correlation between a basis weight of the reference sample P calculated from the reference sample P and the radiation transmission intensity of the reference sample P. Therefore, in this processing, a measurement value can be effectively calibrated without creating measurement gaps in the basis weight measurement using radiations, such as beta-rays or X-rays.

### 4-4. Effect 4

Fourth, in the processing according to the embodiment described above, the measuring device 10 acquires the radiation transmission intensity of the electrode sheet S detected by the detector 20 that scans back and forth along the electrode sheet S in a direction perpendicular to a direction in which the sheet-shaped electrode sheet S is fed out, and acquires the radiation transmission intensity of the reference sample P detected by the detector 20 from at least one of the reference samples P arranged at turnaround positions in back-and-forth scanning of the detector 20. Therefore, in this processing, a measurement value can be effectively calibrated in the basis weight measurement of a sheet-shaped object to be measured using radiations, such as beta-rays or X-rays.

### 4-5. Effect 5

Fifth, in the processing according to the embodiment described above, the measuring device 10 further acquires a radiation transmission intensity of air when the electrode sheet S and the reference sample P are not present by scanning air by the detector 20 at a turnaround position, and calibrates an indication value based on variations of the radiation transmission intensity of air over time. Therefore, in this processing, a measurement value can be effectively calibrated in the basis weight measurement using radiations, such as beta-rays or X-rays while performing zero-point calibration.

### 4-6. Effect 6

Sixth, in the processing according to the embodiment described above, the measuring device 10 identifies a reduction in an irradiation dose of radiations based on variations of the radiation transmission intensity of the reference sample P over time, and calibrate an indication value by correcting a coefficient to be used when the indication value is calculated. Therefore, in this processing, a measurement value can be effectively calibrated by identifying an abnormality due to radiation dose reduction in the basis weight measurement using radiations, such as beta-rays or X-rays.

### 4-7. Effect 7

Seventh, in the processing according to the embodiment described above, the measuring device 10 identifies contamination of a measurement window surface of the detector 20 based on variations of the radiation transmission intensity of the reference sample P over time, and calibrates an indication value by correcting a coefficient to be used when the indication value is calculated. Therefore, in this processing, a measurement value can be effectively calibrated by identifying an abnormality caused by contamination of the measurement window surface in the basis weight measurement using radiations, such as beta-rays or X-rays.

### 4-8. Effect 8

Eighth, in the processing according to the embodiment described above, the measuring device 10 identifies degradation of sensitivity of the detector 20 based on variations of the radiation transmission intensity of the reference sample P over time, and corrects a coefficient to be used when an indication value is calculated, to calibrate the indication value. Therefore, in this processing, a measurement value can be effectively calibrated by identifying an abnormality caused by sensitivity degradation in the basis weight measurement using radiations, such as beta-rays or X-rays.

### 4-9. Effect 9

Ninth, in the processing according to the embodiment described above, the measuring device 10 identifies an abnormality relating to synchronization or a positional relationship between a radiation source of radiations and the detector 20 based on variations of the radiation transmission intensity of the reference sample P over time, and corrects a coefficient to be used when an indication value is calculated, to calibrate the indication value. Therefore, in this processing, a measurement value can be effectively calibrated by identifying a malfunction in the basis weight measurement using radiations, such as beta-rays or X-rays.

### System

A processing procedure, a control procedure, specific names, and information including various kinds of data and parameters described in the document above and the drawings can be arbitrarily changed unless otherwise specified.

Moreover, the respective components of the respective devices illustrated are of functional concept, and it is not necessarily required to be configured physically as illustrated. That is, specific forms of distribution and integration of the respective devices are not limited to the ones illustrated, and all or some thereof can be configured to be distributed or integrated functionally or physically in arbitrary units according to various kinds of loads, usage conditions, and the like.

Furthermore, as for the respective processing functions performed by the respective devices, all or an arbitrary part thereof can be implemented by a CPU and a computer program that is analyzed and executed by the CPU, or can be implemented as hardware by wired logic.

### Hardware

Next, a hardware configuration example of the measuring device 10 that is an information processing apparatus will be explained. Other devices can have a similar hardware configuration. FIG. 10 is a diagram for explaining a hardware configuration example. As illustrated in FIG. 10, the measuring device 10 includes a communication device 10a, a hard disk drive (HDD) 10b, a memory 10c, and a processor 10d. Moreover, respective components illustrated in FIG. 10 are connected to one another through a bus or the like.

The communication device 10a is a network interface card or the like, and performs communication with other servers. The HDD 10b stores a program to implement the functions illustrated in FIG. 3 or a DB.

The processor 10d initiates a process to implement the respective functions explained in FIG. 3 and the like by reading a program to execute processing similar to the respective processing units illustrated in FIG. 3 from the HDD 10b or the like and by deploying it to the memory 10c. For example, this process implements functions similar to the respective processing units included in the measuring device 10. Specifically, the processor 10d reads out a program having functions similar to the acquiring unit 15a, the calculating unit 15b, the calibrating unit 15c, the notifying unit 15d, and the like from the HDD 10b or the like. The processor 10d performs the process to implement processing similar to those of the acquiring unit 15a, the calculating unit 15b, the calibrating unit 15c, the notifying unit 15d, and the like.

As described, the measuring device 10 functions as a device that performs respective kinds of processing methods by reading and executing the program. Moreover, the measuring device 10 can also implement functions similar to those of the embodiment described above by reading out the program described above from a recording medium by a medium reader device, and by executing the read program described above. Other programs in the embodiment are not limited to be executed by the measuring device 10. For example, the present invention can also be applied similarly to a case in which the program is executed by other computers or servers, or by these in cooperation.

This program can be distributed through a network such as the Internet. Furthermore, this program can be recorded on a computer-readable recording medium, such as a hard disk, a flexible disk (FD), a CD-ROM, a magneto optical disk (MO), and a digital versatile disc (DVD), and can be executed by being read by a computer from the recording medium.

### REFERENCE SIGNS LIST

10 Measuring Device
11 Input Unit
12 Display Unit
13 Communication Unit
14 Storage Unit
14a Measurement-Value Storage Unit
14b Reference-Value Storage Unit
14c Calculation-Value Storage Unit
14d Calibration-Value Storage Unit
15 Control Unit
15a Acquiring Unit
15b Calculating Unit
15c Calibrating Unit
15d Notifying Unit
20 Detector
21 Measuring Unit
22 Radiation Source
30 Electronic Balance
31 Measuring Unit
100 Basis-Weight Measurement System

1. A measuring device comprising:
a processor configured to:
acquire first transmission information by scanning an object to be measured with a detector that irradiates a predetermined object of irradiation and detects transmission information of the object of irradiation;
acquire second transmission information by scanning a reference sample generated from the object to be measured with the detector;
calculate a value relating to a weight or a thickness of the object to be measured from the first transmission information by using a correlation between a reference value relating to a weight or a thickness of the reference sample and the second transmission information; and
calibrate the value based on variations of the second transmission information over time.

2. The measuring device according to claim 1, wherein
the processor is configured to further notify an alarm corresponding to an abnormality identified based on variations of the second transmission information over time when the first transmission information exceeds a predetermined value.

3. The measuring device according to claim 1, wherein
the processor is configured to acquire a weight of the reference sample collected as a portion of the object to be measured, as the reference value,
acquire a first transmission intensity of a radiation that passes through the object to be measured, as the first transmission information, and
acquire a second transmission intensity of the radiation that passes through the reference sample, as the second transmission information, and
calculate a basis weight or a thickness of the object to be measured from the first transmission intensity by using a calibration curve indicating the correlation between a basis weight of the reference sample calculated from the weight of the reference sample and the second transmission intensity.

4. The measuring device according to claim 1, wherein
the processor is configured to
acquire the first transmission information detected by the detector that scans back and forth along the object to be measured in a direction perpendicular to a direction in which the sheet-shaped object to be measured is fed out, and
acquire the second transmission information detected by the detector from at least one of the reference samples arranged at turnaround positions when the detector performs back-and-forth scanning.

5. The measuring device according to claim 4, wherein
the processor is configured to
acquire third transmission information when the object to be measured and the reference sample are not present by scanning air with the detector at the turnaround position, and
the calibration unit calibrates the value based on variations of the third transmission information over time.

6. The measuring device according to claim 1, wherein
the processor is configured to
identify a reduction in an irradiation amount of the object of irradiation based on variations of the second transmission information over time, and corrects a coefficient to be used when the value is calculated, to calibrate the value.

7. The measuring device according to claim 1, wherein
the processor is configured to
identify contamination of a measurement window surface of the detector based on variations of the second transmission information over time, and corrects a coefficient to be used when the value is calculated, to calibrate the value.

8. The measuring device according to claim 1, wherein
the processor is configured to
identify sensitivity degradation of the detector based on variations of the second transmission information over time, and corrects a coefficient to be used when the value is calculated, to calibrate the value.

9. The measuring device according to claim 1, wherein
the processor is configured to
identify an abnormality relating to synchronization or a positional relationship between a generation source of the object of irradiation and the detector based on variations of the second transmission information over time, and corrects a coefficient to be used when the value is calculated, to calibrate the value.

10. A measuring method that is performed by a computer, the method comprising:
acquiring first transmission information by scanning an object to be measured with a detector that irradiates a predetermined object of irradiation and detects transmission information of the predetermined object of irradiation;
acquiring second transmission information by scanning a reference sample generated from the object to be measured with the detector;
calculating a value relating to a weight or a thickness of the object to be measured from the first transmission information by using a correlation between a reference value relating to a weight or a thickness of the reference sample and the second transmission information; and
calibrating the value based on variations of the second transmission information over time.
